(19) United States
(12) Patent Application Publication
(10) Pub. No.: US 2010/0050588 A1
(43) Pub. Date: Mar. 4, 2010

(54) Apparatus for harvesting strawberries

(76) Inventor: Carlos S. Ramirez, Salinas, CA (US)

Correspondence Address: Bruce H. Johnsonbaugh;Eckhoff & Hoppe, 8th Floor, 1900 N. California Blvd., Walnut Creek, CA, 94596, US

(21) Appl. No.: 12/583,645

(22) Filed: Aug. 24, 2009

Related U.S. Application Data
(60) Provisional application No. 61/190,150, filed on Aug. 26, 2008.

(51) Int. Cl. A01D 46/00

(52) U.S. Cl. 56/330

(57) ABSTRACT

An apparatus for harvesting strawberries at night is disclosed. An array of high intensity lights is carried by an articulating boom mounted to the chassis of an existing strawberry harvesting machine. The boom moves between an extended position wherein it supports the array of lights above the ground a distance between 10 and 20 feet and behind the harvester chassis a distance between 10 and 19 feet. The massive lighting illuminates a large area allowing handpickers to harvest strawberries at night with the same picking efficiency as experienced during daytime harvesting. The illumination provided by the invention is preferably at least 75 lumens per square foot.

### CROSS REFERENCE TO RELATED APPLICATION

This application claims the benefit of and priority from U.S. provisional application Ser. No. 61/190,150 filed on Aug. 26, 2008.

### BACKGROUND AND BRIEF SUMMARY OF INVENTION

The present invention pertains generally to apparatus for harvesting strawberries at night. More particularly, the invention provides a cost effective and highly efficient apparatus for harvesting strawberries at night.

Strawberries have historically been picked by hand during daylight hours for several reasons. Strawberries in a given field do not ripen at the same time. A strawberry field with a season extending from March through November will provide about 64 pickings during the season. It is critical during each picking that only the berries that are sufficiently ripe are picked. If unripened berries are picked, they will have to be separated and discarded. Discarding unripened berries greatly reduces the yield of the strawberry field. This differential ripening of strawberries renders harvesting by automatic machines impractical since machines are unable at this point in time to automatically locate and select fully ripened berries.

Another complicating factor in harvesting strawberries is that the berries are often occluded by foliage, requiring the picker to look at a given plant from two or more vantage points and/or to brush the foliage away from the berries to be able to view and select only the fully ripened berries for harvesting.

Daytime harvesting of strawberries includes several inherent disadvantages. First, the berries are warm when picked and must be refrigerated as soon as possible, adding cost and shortening shelf life. Secondly, the berries are softer when warm and bruise easily. Thirdly, the pickers tire more easily in the heat of the day, and their efficiency drops.

Efficient nighttime harvesting of strawberries has not yet been done anywhere, to the best of applicant's knowledge. An efficient system of nighttime harvesting would extend shelf life of harvested berries and allow harvesting when the berries are fully ripe with maximum sugar content. A definite need exists to increase the yield from strawberry fields.

Applicant is aware of only one attempt (prior to the present invention) to harvest strawberries at night. That attempt is described in PCT International Publication No. WO 99/09804 which teaches a nighttime strawberry harvester having a row of small lamps 78 suspended relatively close to a horizontal platform on which the pickers lie in a prostrate position (page 3, lines 12-15 and page 6, lines 15-24). The design of that apparatus provides a relatively small illuminated area of strawberry plants. The pickers are lying down and can only pick from an area within arm's reach, i.e., an area about 2 feet by 2 feet.

A further significant disadvantage of the apparatus shown in WO 99/09804 is that the pickers lie prostrate and are towed feet first through the strawberry field. The pickers have only a momentary and partially obstructed view of the plants (obstructed by the conveyor) below the surface on which they lay as the harvester is pulled through the field. The head and arms of the pickers are between the overhead lamps 78 and the strawberries, causing interference with the illumination. FIGS. 6 and 7 are reproductions of FIGS. 1 and 2 (slightly modified) of WO 99/09804 referred to above. That unit is towed to the right as shown by directional arrow 200. The pickers (such as 210) lie face down on platform 14. A light source 78 illuminates a small portion of the field behind platform 14. The pickers lying on platform 14 have only a momentary, obstructed field of view of a small band of illuminated strawberries. The momentary and obstructed view inherently limits the efficiency with which the picker can harvest the ripe strawberries while lying face down.

In contrast, the present invention provides the pickers a much larger unobstructed view with massive illumination and allows the pickers substantially more time to select the fully ripened strawberries from a much larger area. According to the present invention, the pickers move on foot behind the harvesting apparatus and have a much fuller and unobstructed field of view of the strawberry plants, essentially as though they were moving through the field on foot in broad daylight. Utilizing the present invention, the pickers can easily view strawberries 5 feet ahead and 5 feet to each side.

In contrast to the disclosure of WO 99/09804, the present invention provides relatively massive and relatively extensive lighting which illuminates a rectangular area approximately 20 feet wide and 100 feet long. According to the present invention, a preferred embodiment utilizes an array of eight light sources, each having 1,250 watt output for a total of 10,000 watts, which produces a light intensity of approximately 5 watts and at least 75 lumens per square foot of illuminated strawberry plants (i.e. at least 15 lumens per watt). Using incandescent bulbs, 75 or more lumens per square foot are achieved using parabolic reflectors. This light intensity is what is believed achieves an efficient level of light. Furthermore, according to the present invention, the light sources are preferably elevated a rather substantial distance above the strawberry plants (15 to 20 feet) and are also preferably positioned horizontally at a substantial distance away from the body of the harvesting machine, preferably 14 to 19 feet. The present invention directs the light downwardly at the strawberry plants.

The massive and intense amount of illumination provided by the present invention facilitates a high degree of efficiency in the picking of the strawberries. The pickers have a large field of view and enough time to be able to determine which berries are ready to be picked and which berries need further ripening on the plant. We have found that the nighttime picking efficiency utilizing the illumination system of the present invention is the same as daytime efficiency of picking. The present invention preserves the efficiency of daytime harvesting while also including the above-described significant advantages of nighttime harvesting!

A primary object of the invention is to achieve nighttime harvesting of strawberries wherein the efficiency of picking is as great as in daylight.

A further object of the invention is to provide an illumination system which may be easily retrofitted onto an existing strawberry harvesting machine to allow nighttime harvesting.

Another object of the invention is to achieve harvesting of strawberries having longer shelf life, less bruising, and greater sugar content as compared to prior art strawberry harvesting.

Further objects and advantages will become apparent from the following description and drawings,

### BRIEF DESCRIPTION OF DRAWINGS

FIG. 1 is a schematic representation illustrating the illumination system of the invention as applied to a prior art strawberry harvesting machine;

FIG. 2 is a schematic illustration of a side view of the lighting system of the invention showing the height above ground and the distance behind the conveyor chassis at which the light is suspended;

FIG. 3 is a schematic illustration showing how the conveyor is lifted and moved from one side of the chassis to the opposite side of the chassis so that the harvester can move in the opposite direction;

FIG. 4 illustrates how the boom supporting the light arrays are folded downwardly onto the top of the harvester chassis to allow the conveyor to be moved from side-to-side;

FIG. 5 is a plan view showing how the harvester 10 is moving through a strawberry field with the light fixtures extended behind the chassis of the harvester; and

FIGS. 6 and 7 are illustrations of the prior art, slightly modified to illustrate the direction of movement and the positioning of a picker on the apparatus.

### DETAILED DESCRIPTION OF DRAWINGS

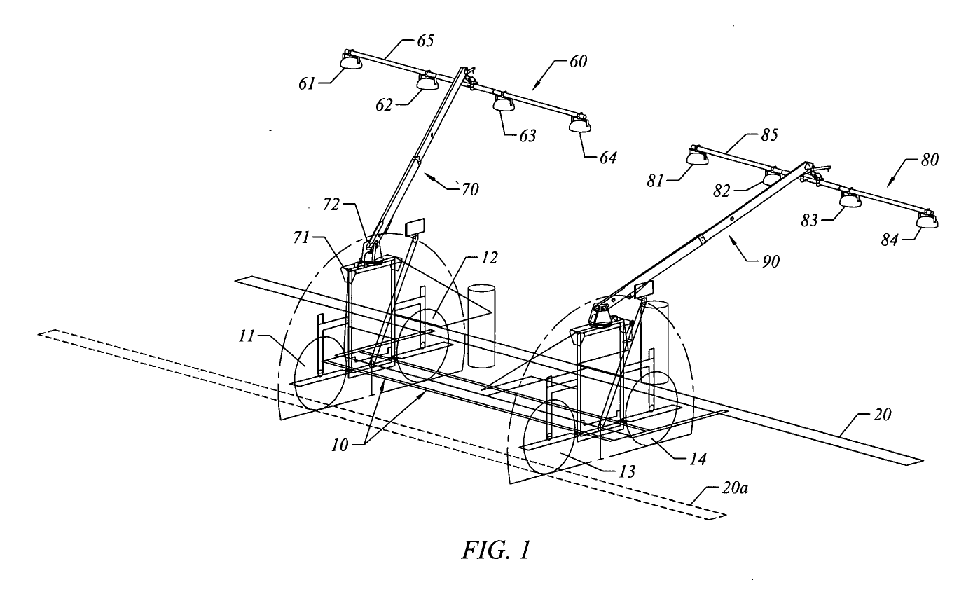

FIG. 1 is a schematic representation illustrating the “concept” of the invention. A conventional prior art harvesting machine 10 is illustrated which is used for daytime harvesting of strawberries. The preferred harvesting machine is manufactured by Colby Manufacturing of Oxnard, Calif.

The novel lighting system of the invention preferably includes a first lighting array 60 and a second lighting array 80. Each of the lighting arrays includes four fixtures 61-64 and 81-84. Each fixture of FIG. 1 carries an individual 1250 watt incandescent bulb. Other types of bulbs may be used so long as the color of the berries is not affected by the bulb output. The fixtures 61-64 and 81-84 are each suspended on support rods 65 and 85. The support rods 65 and 85 are in turn supported by hydraulically actuated, articulating and telescopic booms 70 and 90. The booms 70 and 90 are attached to the top of the chassis 11 of harvester 10 by mounting plates 71 and 91 and articulating joints or turrets 72 and 92. The booms 70 and 90 are capable of elevating the light fixtures to a level of between 15 and 20 feet above the strawberry plants.

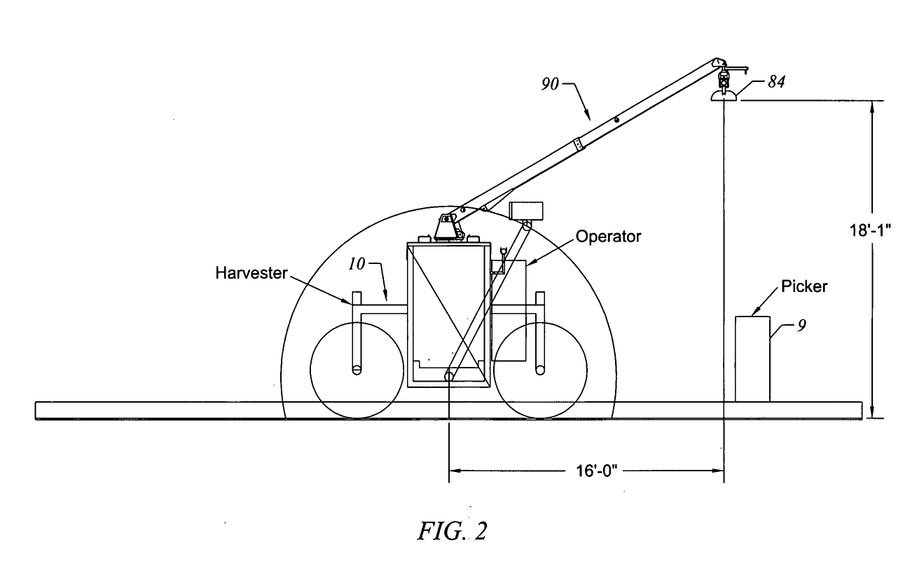

As shown in FIG. 2, booms 70 and 90 are also capable of extending the light fixtures a horizontal distance rearwardly of 19 feet, with the preferred distance of 16 feet shown in FIG. 2. In FIG. 2, the rectangular shape 9 illustrates the position of a picker moving on foot behind harvester 10 and beneath light fixture 84. The preferred height of light fixture above ground is 18 feet, 1 inch as shown in FIG. 2. The preferred height range is from 15 to 20 feet, but 10 feet is acceptable. As noted above, the massive lighting provided by light fixtures 61-64 and 81-84 provides a large and unobstructed illuminated field of view for the picker that is comparable to full direct sunlight, in the sense that the berries are picked with the same efficiency as in daylight.

As shown in FIG. 1, the harvester 10 includes a harvester conveyor 20 onto which the harvested strawberries are placed by the individual pickers. When the harvester reaches the end of a given pass through the field, as is known in the prior art, the harvester support wheels 11-14 pivot through 90° and allow the harvesting machine to move laterally so that the machine can proceed with another pass through the strawberry field in the opposite direction. The harvester continues this back and forth motion through parallel rows of strawberries without having to pivot at the end of a row. Before the harvesting machine can move in the opposite direction, the harvester conveyor 20 must be lifted above the harvesting machine 10 and moved from a first position 20 to the position shown in phantom in FIG. 1 as 20a (as known in the art). The first and second positions 20 and 20a are on opposite sides of the chassis 11 of harvester 10. In order to move the conveyor from the position 20 in FIG. 1 to the position 20a, the lighting apparatus including booms 70 and 90 and light fixtures 61-64 and 81-84 must be folded downwardly into a retracted position against the top of the chassis 11 of harvester 10.

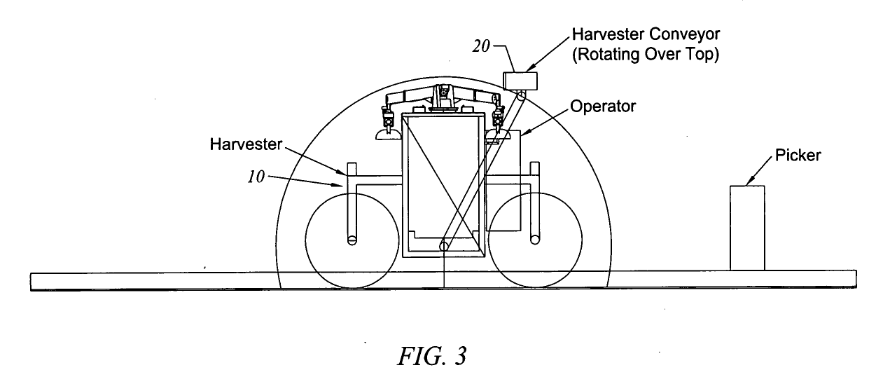

FIG. 3 shows conveyor 20 as it is being moved from the position shown as 20 in FIG. 1 to the position shown as 20a in phantom in FIG. 1.

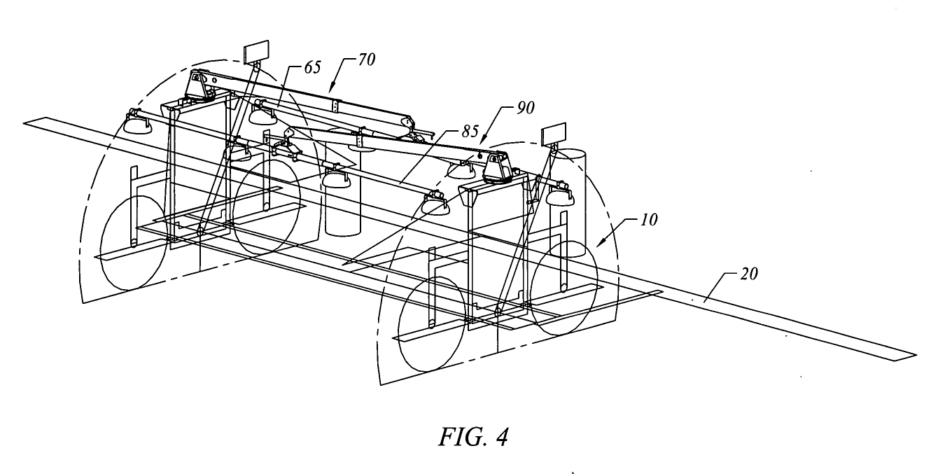

FIG. 4 illustrates how booms 70 and 90 are folded downwardly onto the top of harvester 10 into a retracted position to allow the conveyor 20 to be moved as shown by arrows 99 in FIG. 3. Booms 70 and 90 are shown in their closed or folded positions in which they extend generally horizontally from each end of the chassis of harvester 10 towards the opposite end of the chassis. The support rods 65 and 85 are swiveled to be generally parallel to booms 70 and 90.

The booms 70 and 90 each rotate around articulating turrets 72 and 92 through an angle of 240° or more to allow the light fixtures to be positioned behind the harvester 10 regardless of which direction the harvester is moving in the strawberry field. Each boom 70 and 90 is capable of elevating to an angle of approximately 32° above horizontal and to an angle of at least −2° below horizontal.

It is significant to note that the lighting system of the present invention may be retrofitted onto an existing harvester 10.

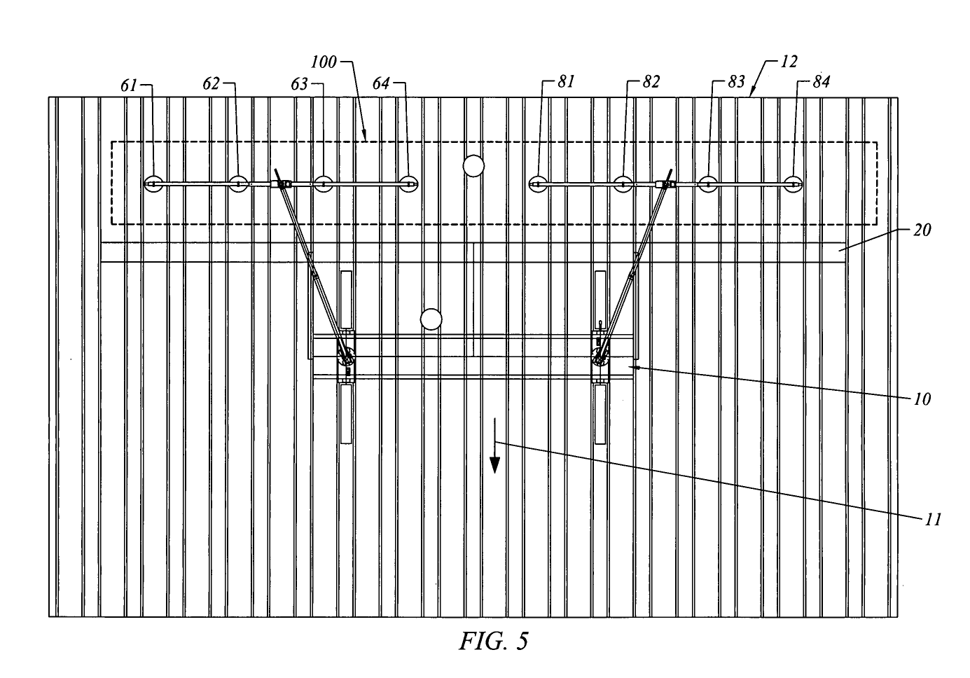

FIG. 5 is a plan view of the harvester 10 moving in the direction of arrow 11 through a strawberry field 12. Light fixtures 61-64 and 81-84 illuminate a relatively large rectangular area shown by dashed line 100. It is significant to note that the illuminated area 100 is not obstructed by any portion of the chassis of harvester 10, by conveyor 20 or by the bodies of the pickers. The pickers on foot beneath the light fixtures have a view of the strawberry plants that is unobstructed and is illuminated to a degree that is comparable with full sunlight.

The apparatus of the invention provides for the first time sufficient and unobstructed illumination of a strawberry field to allow nighttime harvesting in a cost effective manner. The intense illumination reduces the waste otherwise caused by the picking of berries that are not sufficiently ripe.

The light fixtures 61-64 and 81-84 may use high output incandescent bulbs. This massive output is directed downwardly with minimum loss, since each fixture 61-64 and 81-84 is parabolic in shape with highly reflective surfaces.

The illumination system of the invention performs adequately when the lights are more than 10 feet above ground, and performs best when the lights are between 15 and 20 feet above ground.

The illumination system performs adequately when the lights are positioned more than 10 feet behind the chassis, and performs the best when the lights are positioned between 14 and 19 feet behind the chassis.

The pickers are provided a field of view by the invention comparable to the field of view in daytime harvesting, i.e., the pickers are able to easily view berries at least 5 feet ahead and at least 5 feet to each side.

The invention is not limited to incandescent bulbs. Other bulbs may be used provided the output does not affect the apparent color of the berries. Other possible bulbs include fluorescent, arc lamp and gas discharge bulbs.

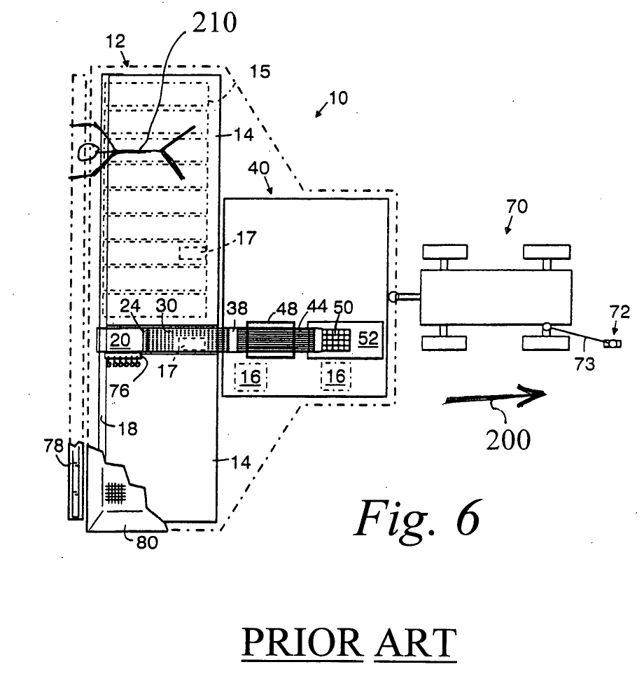

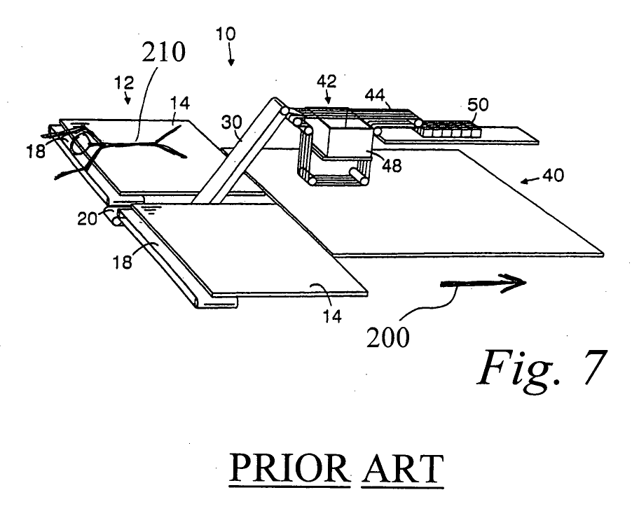

FIGS. 6 and 7 illustrate the prior art and are described above at pages 2-3.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. In a strawberry harvesting machine that moves back and forth along parallel rows of strawberry plants without pivoting at the end of a row, wherein said machine includes a chassis, pivotable wheels to allow the machine to move transversely and without pivoting at the end of a row, a conveyor carried by said chassis behind the direction of travel of said chassis and oriented to transport harvested strawberries transversely to said direction of travel, said conveyor belt being movable between a first position on one side of said chassis and a second position on the opposite side of said chassis, and conveyor movement means for lifting and moving said conveyor from said first position to said second position before said harvesting machine moves in an opposite direction of travel, the improvement for nighttime harvesting, comprising:
at least one articulating and telescopic boom carried by said chassis,
an array of high intensity lights carried by said boom,
said boom being movable between a first, extended position wherein said boom extends upwardly and rearwardly relative to the direction of movement of said chassis to suspend said light array at least ten feet above the ground and at least ten feet behind said chassis, and
a second, retracted position wherein said boom and said light array are folded downwardly against said chassis to allow said conveyor to be moved over said chassis from its first to its second position,
whereby when said boom is in its extended position, said light array forms an unobstructed night time illumination of strawberry plants so that pickers moving on foot behind said machine have an unobstructed view of strawberries to be picked comparable to the view seen by pickers moving on foot behind said machine in daylight, and
actuation means for moving said boom between its first, extended position and its second, retracted position.

2. The apparatus of claim 1 wherein the illumination of strawberry plants is at least 75 lumens per square foot.

3. The apparatus of claim 1 wherein said boom and light array are retrofitted onto an existing strawberry harvester.

4. The apparatus of claim 1 wherein two booms are carried by said chassis, and each light array includes four incandescent lights each having an output of 1250 watts and at least 15 lumens per watt.

5. The apparatus of claim 4 wherein each of said booms is telescopic and hydraulically actuated.

6. The apparatus of claim 1 wherein said light array is carried at a height above ground of between 15 and 20 feet.

7. The apparatus of claim 1 wherein said light array is carried at a distance behind said chassis of between 14 and 19 feet.
